(19) United States
(12) Patent Application Publication
(10) Pub. No.: US 2013/0170518 A1
(43) Pub. Date: Jul. 4, 2013

(54) FAN TESTING APPARATUS AND TESTING METHOD

(71) Applicant: YAO-TING CHANG, Tu-Cheng (TW)

(72) Inventor: YAO-TING CHANG, Tu-Cheng (TW)

(73) Assignee: HON HAI PRECISION INDUSTRY CO., LTD., Tu-Cheng (TW)

(21) Appl. No.: 13/457,514

(22) Filed: Apr. 27, 2012

(30) Foreign Application Priority Data
Dec. 29, 2011 (TW) 100149680

(51) Int. Cl. G01K 13/00

(52) U.S. Cl. 374/141; 374/E13.001

(57) ABSTRACT

A fan testing apparatus includes an air duct defining opposite air inlet and air outlet, a heating member received in the air duct, a first thermometer attached to the heating member, and a second thermometer positioned at the inlet of the air duct. The fan generates airflow in the air duct through the inlet and out of the air duct through the outlet to cooling the heating member. A surface temperature of the heating member is measured by the first thermometer. An environmental temperature at the air inlet is measured by the second thermometer.

### BACKGROUND

1. Technical Field

The present disclosure relates to a testing apparatus and a testing method, and particularly to a testing apparatus and a testing method for a fan.

2. Description of Related Art

Many electronic products are equipped with one or more fans for heat dissipation. The fans mounted in the electronic product should performance well enough to prevent the electronic product from overheating. Fan testing may require expensive equipment and take a lot of time. Therefore, only samples from production batches of fans may be tested, which means some malfunctioning fans may be passed along for use.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric view of an exemplary embodiment of a fan testing apparatus.

FIG. 2 is an isometric view of the fan testing apparatus of FIG. 1 together with a reference fan and a to-be-tested fan.

FIG. 3 is a flowchart of an exemplary embodiment of a fan testing method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references can mean “at least one.”

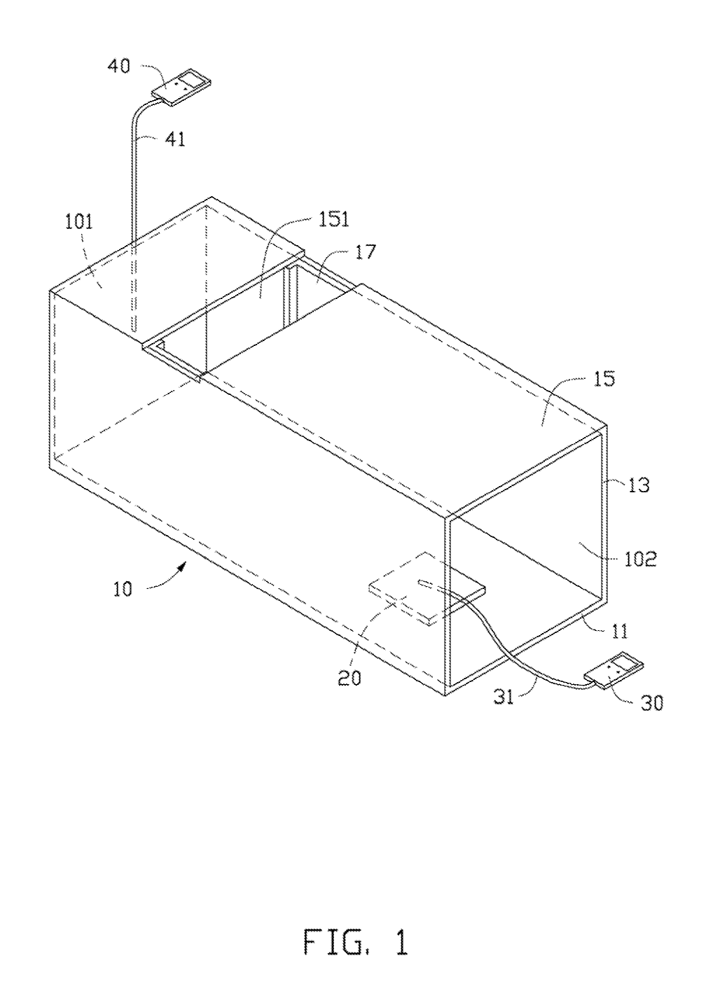

Referring to FIG. 1, an exemplary embodiment of a fan testing apparatus includes an air duct 10, a heat generating member 20, a first thermometer 30, and a second thermometer 40.

The air duct 10 is formed by a bottom wall 11, two opposite sidewalls 13 perpendicularly extending from opposite sides of the bottom wall 11, and a top wall 15 connected between tops of the sidewalls 13. An air inlet 101 and an air outlet 102 are respectively defined in opposite ends of the air duct 100. An access hole 151 is defined in the top wall 15 adjacent to the air inlet 101. Opposite guide rails 17 are correspondingly attached to inner sides of the sidewalls 13, right below the hole 151.

In the embodiment, the heat generating member 20 is an electrothermal metal block. The heat generating member 20 is positioned on the bottom wall 11, adjacent to the air outlet 102 of the air duct 10.

In the embodiment, the first thermometer 30 includes a thermocouple probe contacting a top of the heat generating member 20. The second thermometer 40 includes a thermocouple probe positioned at the inlet 101 of the air duct 10.

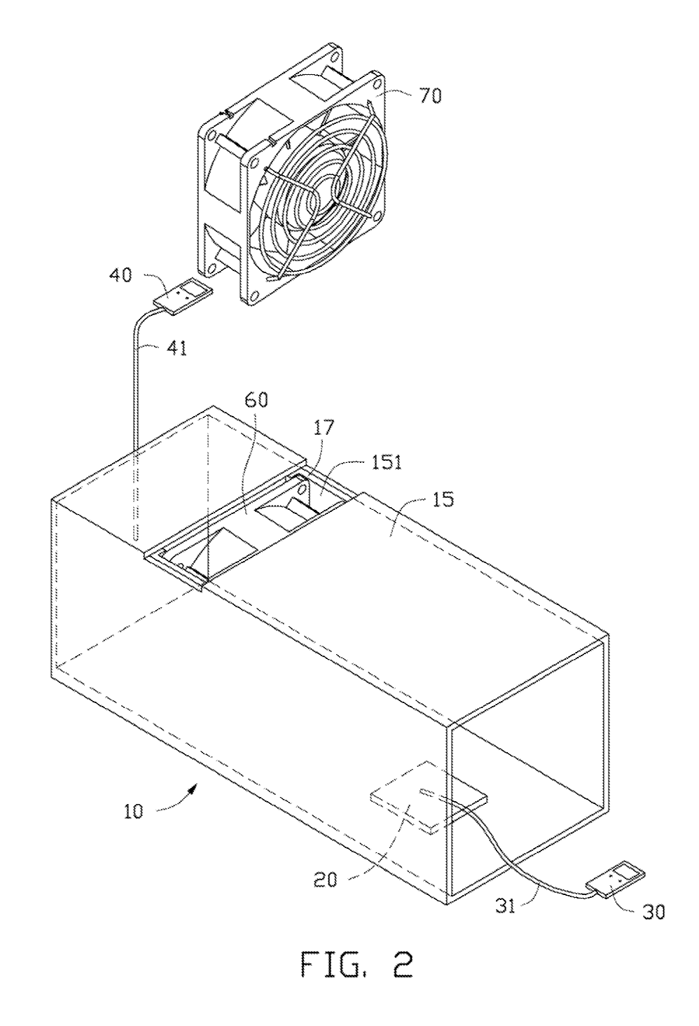

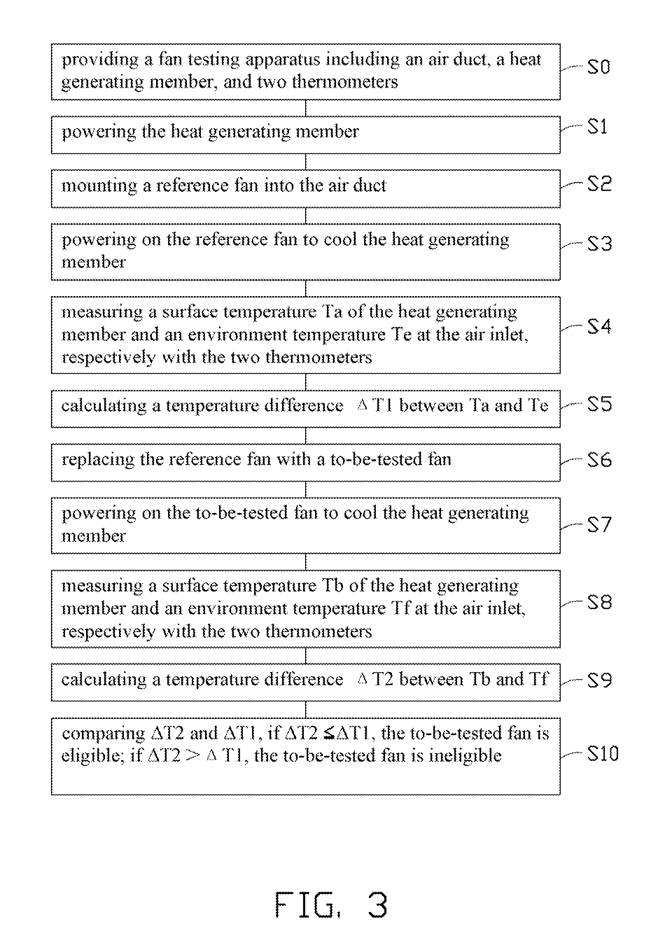

Referring to FIGS. 2 and 3, an embodiment of a fan testing method includes steps as follows:

Step S0, a fan testing apparatus as described above is provided;

Step S1, the heat generating member 20 is powered to be heated to a certain temperature.

Step S2, a reference fan 60, which is eligible for a certain application, is slid into the air duct 10 along the guide rails 17, through the access hole 151.

Step S3, the reference fan 60 is powered on and controlled with a PWM signal input to the reference fan 60 to control rotating speed of the reference fan 60. The reference fan 60 generates an airflow entering the air duct 10 through the air inlet 101, and out of the air duct 10 through the air outlet 102.

Step S4, a surface temperature Ta of the heat generating member 20 is measured by the first thermometer 30. Environmental temperature Te at the air inlet 101 is measured by the second thermometer 40.

Step S5, a temperature difference ΔT1 is found using the formula Ta−Te.

Step S6, the reference fan 60 is taken out of the air duct 10, and a to-be-tested fan 70 is slid into the air duct 10 along the guide rails 17, through the access hole 151.

Step S7, the to-be-tested fan 70 is powered on, and controlled with the same PWM signal as that be inputted to the reference fan 60.

Step S8, a surface temperature Tb of the heat generating member 20 and a environmental temperature Tf at the air inlet 101 are respectively measured by the first thermometer 30 and the second thermometer 40.

Step S9, a temperature difference ΔT2 is found using the formula Tb−Tf. The smaller the temperature difference ΔT2 is, the better performance of the to-be-tested fan 70.

Step S10, the temperature difference ΔT2 is compared with the temperature difference ΔT1. If the temperature difference ΔT2 is smaller than or equal to the temperature difference ΔT1, the to-be-tested fan 70 is eligible. If the temperature difference ΔT2 is greater than the temperature difference ΔT1, the to-be-tested fan 70 is ineligible.

It is to be understood, however, that even though numerous characteristics and advantages of the embodiments have been set forth in the foregoing description, together with details of the structures and functions of the embodiments, the disclosure is illustrative only, and changes may be made in detail, especially in the matters of arrangement of parts within the principles of the present disclosure to the full extent indicated by the broad general meaning of the terms in which the appended claims are expressed.

What is claimed is:

1. A fan testing apparatus comprising:
a hollow air duct defining an air inlet and an air outlet respectively at two opposite ends thereof;
a heat generating member mounted in the air duct adjacent to the air outlet;
a first thermometer contacting the heat generating member to measure a surface temperature of the heat generating member; and
a second thermometer positioned at the inlet of the air duct to measure an environment temperature at the air inlet.

2. The fan testing apparatus of claim 1, wherein an access hole is defined in the air duct adjacent to the air inlet of the air duct, which is for a fan inserted into or take out of the air duct.

3. The fan testing apparatus of claim 2, wherein opposite guide rails are attached to insides of the air duct, aligned with the access hole.

4. The fan testing apparatus of claim 3, wherein the air duct is bounded by a bottom wall, two sidewalls perpendicularly extending from opposite sides of the bottom wall, and a top wall connected between tops of the sidewalls, the air inlet and the air outlet are respectively defined in opposite ends of the air duct, the access hole is defined in the top wall of the air duct, adjacent to the air inlet, the guide rails are correspondingly attached to inner sides of the sidewalls.

5. The fan testing apparatus of claim 1, wherein each of the first and second thermometers comprises a thermocouple probe.

6. A fan testing method comprising:
providing a fan testing apparatus comprising:
an air duct defining an air inlet, and an air outlet;
a heat generating member mounted in the air duct adjacent to the air outlet;
a first thermometer contacting the heating member; and
a second thermometer positioned at the inlet of the air duct;
powering the heat generating member to a certain temperature;
mounting a reference fan into the air duct;
powering on the reference fan to generate an airflow entering the air duct through the air inlet, and out of the air duct through the air outlet, thereby cooling the heat generating member;
measuring a surface temperature Ta of the heat generating member with the first thermometer, and an environment temperature Te at the air inlet with the second thermometer;
calculating a temperature difference ΔT1, which is equal to Ta−Te;
taking the reference fan out of the air duct, and mounting a to-be-tested fan into the air duct;
powering on the to-be-tested fan to cool the heat generating member;
measuring a surface temperature Tb of the heat generating member with the first thermometer, and an environment temperature Tf at the air inlet with the second thermometer;
calculating a temperature difference ΔT2, which is equal to Tb−Tf;
comparing the temperature difference ΔT2 with the temperature difference ΔT1, if the temperature difference ΔT2 is smaller than or equal to the temperature difference ΔT1, the to-be-tested fan is eligible; if the temperature difference ΔT2 is greater than the temperature difference ΔT1, the to-be-tested fan is ineligible.

7. The testing method of claim 6, wherein mounting the reference fan or the to-be-tested fan into the air duct through an access hole defined in air duct adjacent to the air inlet.
